(19) United States
(12) Patent Application Publication
(10) Pub. No.: US 2016/0035314 A1
(43) Pub. Date: Feb. 4, 2016

(54) DISPLAY WITH FIELD SEQUENTIAL COLOR (FSC) FOR OPTICAL COMMUNICATION

(71) Applicant: Pixtronix, Inc., San Diego, CA (US)

(72) Inventor: Paul Penchin Pan, San Diego, CA (US)

(21) Appl. No.: 14/449,466

(22) Filed: Aug. 1, 2014

(51) Int. Cl. G09G 5/00; G09G 3/34

(52) U.S. Cl. CPC G09G 5/006; G09G 3/346; G09G 2370/18

(57) ABSTRACT

This disclosure provides systems, methods and apparatus for providing displays. In one aspect, a display has an optical data path for transmitting data between a controller and an array of display elements. The controller couples to a transmitter for transmitting an optical signal and the display elements couple to a receiver that receives optical signals. The transmitter transmits an optical signal that carries control data for controlling the operation of the display element. The receiver receives the control data and provides the control data to a driver that uses the control data to control the operation of the display element. In some implementations, the control data is multiplexed with image data and communication data to provide an optical data path that carries image data and control data for forming an image and that carries communication data that can propagate through the display and to a remote location.

### TECHNICAL FIELD

This disclosure relates to displays that employ electromechanical systems that operate as light modulators to create an image and to displays that use control signals to control the operation of the light modulators, as well as to other electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

MEMS devices, arranged in arrays, can be used to create displays. The array is placed in front of a display surface and light is passed through the array and on to the display surface. As the light passes through the array, the MEMS devices are controlled to adjust how much light passes through a MEMS device and onto the display surface.

To form an image, the display employs an array with a large number of MEMS devices. Each MEMS device is to be controlled, so that each MEMS device transmits the correct light to form a portion of the image. In a conventional display, control circuitry communicates with a display driver that controls the operation of the MEMS devices. Typically, the display driver connects to the individual MEMS devices through high-speed scalable low voltage signaling links (SLVS links) Although SLVS links can work quite well, they tend to provide low data throughput and require substantial power to carry signals to the MEMS devices. Increasing power can, in turn, further limit data transfer speeds through the SLVS links due to an increase in electromagnetic interference (EMI).

### SUMMARY

The systems, methods and devices of this disclosure each have several innovative aspects, no single one of which is solely responsible for the desirable attributes disclosed herein.

One innovative aspect of the subject matter described in this disclosure can be implemented in a display including a light modulator capable of modulating light. The display further including a receiver for receiving optical signals, a display controller capable of generating control data for operating the light modulator, and a transmitter coupled to the display controller and capable of transmitting to the receiver an optical signal carrying the control data for controlling operation of the light modulator. In some implementations, the receiver can include a driver circuit coupled to the light modulator and having an optical detector capable of detecting optical signals. The receiver also can include a color filter capable of filtering the optical signal.

In some implementations, the transmitter can include an infrared light source capable of generating the optical signal in the infrared spectrum or a light source capable of generating the optical signal with a plurality of wavelengths. The transmitter also can include a switching circuit capable of generating the optical signal as a series of optical pulses. In some implementations, the switching circuit switches at a rate of between 2 KHz and 500 MHz. The display also can include an interface capable of communicating with a processor to receive an image signal representative of an image for display. In some implementations, the display also can include a multiplexer capable of encoding communication data and control data within the optical signal. In some implementations, the display may include signaling links capable of electrically connecting the controller with the light modulator. In some implementations, the light modulator can include an array of light modulators arranged in alignment with an array of apertures.

In some implementations, the display can include a waveguide optically coupled to the transmitter capable of carrying the optical signal to the receiver. The display also can include a sequence controller capable of moving the light modulators to block light from passing through the apertures prior to transmitting an optical signal carrying control data. The display also can include a processor capable of communicating with the display, the processor being capable of processing image data, and a memory device capable of communicating with the processor. In some implementations, the display can include an image source module capable of sending the image data to the processor, wherein the image source module includes at least one of a receiver, transceiver, and transmitter. Additionally, the display also may include an input device capable of receiving input data and communicating the input data to the processor.

Another innovative aspect of the subject matter described in this disclosure can be implemented in a display device having a light modulator including a receiver for receiving optical signals, a controller coupled to the light modulator, wherein the controller generates control data for operating the light modulator, a processor, wherein the processor is capable of generating a communication signal having encoded information, and a transmitter coupled to the controller, wherein the transmitter is capable of transmitting an optical signal carrying the control data to the receiver, and an optical signal carrying the communication signal. In some implementations, the light modulator includes an array of light modulators arranged in alignment with an array of apertures. In some implementations, the transmitter is configured to transmit the optical signal carrying the communication signal to a remote location. The transmitter can include a switching circuit capable of generating the optical signal as a series of optical pulses, and in some implementations, the switching circuit switches at a rate of between 2 KHz and 500 MHz. In some implementations, the display device can include a multiplexer capable of encoding the communication signal and the control data within the optical signal. The display also can include a spatial multiplexer capable of multiplexing the communication signal across a plurality of apertures within the array. In some implementations, the communication signal has a data transmission rate of 2 Kbps to 500 Mbps.

Another innovative aspect of the subject matter described in this disclosure can be implemented in a system for communicating information to a remote location, the system including a transmitter having a display including a light modulator positioned in alignment with an aperture, the light modulator capable of moving between an open and closed position to modulate light passing through the aperture, a communication processor capable of generating an optical communication signal having encoded information, and a transmitter coupled to the communication processor capable of transmitting through the aperture when the light modulator is in the open position, the optical communication signal transmitting to a remote location. In some implementations, the system can further include a display controller capable of controlling the light modulator to form an image and moving the light modulator to an open position during formation of an image to allow the optical communication signal to pass through the aperture. In some implementations, the display controller moves the light modulator between an open and closed position at a frequency greater than 60 Hz.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows an example display having an optical data connection between a controller and an array of display elements.

FIG. 4 shows example timing diagrams for signals communicated through an optical data connection.

FIGS. 5A and 5B show an example display having an optical data connection for communicating with a display element and with a remote device.

FIGS. 6A and 6B show an example of data to be encoded in an optical signal.

FIG. 7 shows an example lamp driver for high frequency switching of a lamp.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The systems and methods described herein include displays that generate an image by having a display controller that operates an array of light modulating devices. In some implementations, the light modulating devices are MEMS devices that have a shutter which slides back and forth over an aperture. Light passing through the aperture is modulated by the sliding shutter, and the modulated light forms, at least part of, an image that is presented by the display. In some implementations, a receiver for receiving optical signals is connected to the MEMS shutter devices. A transmitter that transmits optical signals is connected to the display controller. The display controller can send control signals for controlling the motion of the MEMS shutter devices to the transmitter and the transmitter can generate an optical signal that transmits the control signal, typically as pulses of light. The receiver that is connected to the MEMS shutter devices can receive the optical signal and decode the control signal that is encoded within the optical signal. A driver circuit coupled to the receiver can use that control signal to drive the operation of the MEMS shutter devices.

In some implementations, the device also includes a multiplexer that can encode image data and control data into the optical signal. The image data, typically, includes color information that can select the color of the light that the MEMS shutter device modulates. The image data and the control data are multiplexed, for example, using time division multiplexing, and the multiplexed signal is used to drive a light source, such as one or more LED lamps. The LED lamps generate pulses that form an optical signal which carries the image and control data as encoded information.

In some implementations, the device also includes a communication processor that generates a communication signal having encoded information. The encoded information can be any type of information, such as by way of example, identification information, biometric data, motion data, gesture data, device status, data files or any other type of information that can be encoded into a data stream and transmitted optically. The communication signal can be encoded by the multiplexer into the optical signal and transmitted along with the control data. The communication signal may be carried with light that forms the image on the display and can pass through the aperture and past the MEMS shutter devices to propagate to a location that is remote from the display. In this way the communication signal can propagate the encoded information, such as the identification information, to a remote location. Optionally, a receiver at the remote location can receive the communication signal and extract the encoded information, such as the identification information, for use by the receiver. In some implementations, the communication signal can be encoded with a control mark that can prevent a camera or other recording device from recording material presented on the screen of the display. In some implementations, the control mark is encoded within the backlight of the display. This control mark may prevent a camera from recording copyrighted material or confidential material, such as credit card information or other confidential information.

Particular implementations of the subject matter described in this disclosure can be implemented to realize one or more of the following potential advantages. In some implementations, the systems and methods described herein can increase the rate of data throughput between a controller and a light modulator. Additionally, the systems and methods described herein may provide reduced power consumption and electro-magnetic interference (EMI) for transferring data between the controller and the light modulators. Further, the display systems and methods described herein may allow data communication with remote receivers at the same time that images are being presented on the display, allowing for transmission of a range of data.

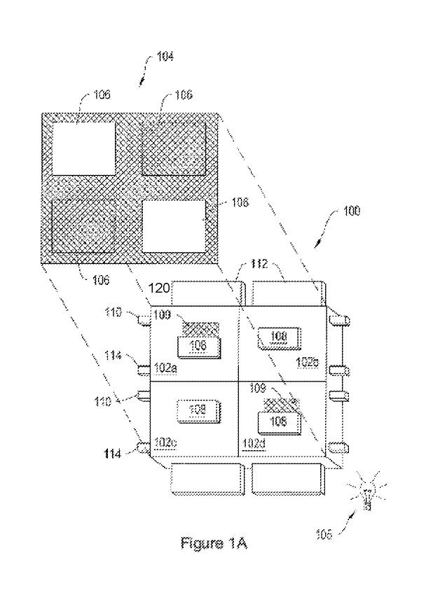

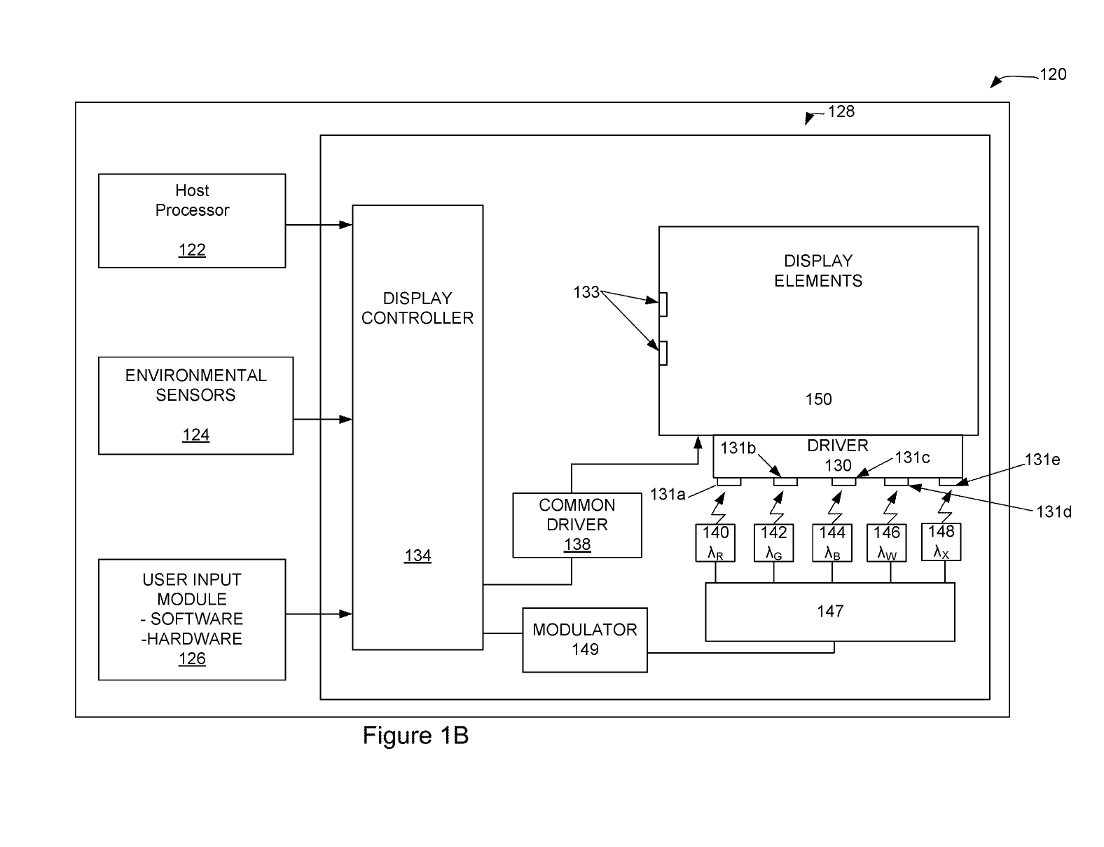

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source (not shown).

The display apparatus 128 includes a driver 130, that acts as a scan driver (also referred to as write enabling voltage sources) and one or more data drivers (also referred to as data voltage sources). The display apparatus 128 also includes a controller 134, common drivers 138, lamps 140-148, lamp drivers 147 and an array of display elements 150, such as the light modulators 102 shown in FIG. 1A.

The driver 130 couples to the display elements 150 and generates the appropriate voltages to apply to interconnects, such as the write-enable interconnect 110 and data interconnect 112 depicted in FIG. 1A. The driver 130 may be an integrated circuit that is including transistors, capacitors and other electrical elements for generating voltages that can be used to actuate the display elements. In some other implementations, the driver 130 can be a separate circuit that electrically connects through the interconnects to the display elements. In either case, the driver 130 generates the appropriate voltages to apply to a given row of pixels, to prepare the pixels in the row to accept new shutter movement instructions. The voltages provided by the driver 130 can be movement instructions in the form of data voltage pulses. The data voltage pulses applied to the interconnects, in some implementations, directly contribute to the electrostatic movement of the display elements 150. For example, the display elements 150 that include MEMS shutter devices, such as the MEMS shutter devices 102 depicted in FIG. 1A, have shutters 108 that can move in response to the data voltage pulses applied to the interconnects. Thus, the application of these drive voltages results in the electrostatic driven movement of the shutters 108. In some other implementations, the data voltage pulses control switches, such as transistors or other non-linear circuit elements that control the application of separate drive voltages, which are typically higher in magnitude than the data voltages, to the light modulators 102. In either case, the driver 130 can generate voltages that provide the display elements 150 with instructions for modulating light passing through the aperture 109. The shutters are arranged in an array of rows and columns and each shutter is disposed in alignment with an aperture 109. Light from the light source 105 passes through the aperture 109; the shutter 102 may be positioned relative to the aperture 109 to obstruct the light traveling through the aperture or to allow the light to pass through the aperture. The shutters 102 are electromechanical devices that move back and forth in response to voltage pulses that act as electrical actuation signals, or movement instructions. These electrical actuation signals are generated by the driver 130 and drive the operation of the shutters 102.

In some implementations, the driver 130 includes one or more optical receivers 131. The optical receivers 131 can have an optical detector, such as a photodiode, for detecting optical signals. In some implementations, the optical receivers 131 on the driver 130 can consist of photodiodes connecting to a transimpedance amplifier (TIA) to convert photons to electrical signals. The optical receivers 131 are arranged to be in optical communication with the lamps 140-148, such that light transmitted from the lamps 140-148 may be received by the optical receivers 131. In the non-limiting depicted implementation, the driver 130 has five optical receivers 131a-131e, each of which is disposed in opposition to a lamp 140-148. Each lamp generates light of a certain wavelength or wavelengths (color). For example, the five lamps 140-148 may generate light of wavelengths red, green, blue, white and infra-red respectively. In some implementations, the optical receivers 131a-131e include an optical filter that selectively passes light of a certain wavelength or of certain wavelengths, such as red light or white light, to the optical receiver. Control signals encoded in light transmitted from a lamp of a certain wavelength or wavelengths will be received by an optical receiver having a filter that passes that wavelength or wavelengths. This allows the optical receivers to receive multiple control signals simultaneously. Additionally, this allows for directing a control signal to an optical receiver having a filter that passes a particular wavelength and to block other optical receivers 131a-131e from receiving or processing that control signal, which is transmitted at a wavelength outside of the filter pass range of the optical filter used with those optical receivers 131a-131e. Thus, the optical receivers 131a-131e can receive different optical signals. In some implementations, the display elements 150 connect to a driver 130 and the driver 130 receives control signals that provide movement instructions for each display element 150. In some other implementations, each display element in the array of display elements 150 has a separate driver 130 that receives control signals with movement instructions for that respective display element in the array. In some implementations, two or more drivers 130 are provided and each driver processes control signals and movement instructions for two or more display elements within the array of display elements 150.

In some implementations of the display apparatus, the driver 130 is capable of providing analog data voltages to the array of display elements 150, especially where the luminance level of the image is to be derived in analog fashion. In analog operation, the display elements are designed such that when a range of intermediate voltages is applied by the driver 130, there results a range of intermediate illumination states or luminance levels in the resulting image. In some other implementations, the driver 130 is capable of applying a reduced set, such as 2, 3 or 4, of digital voltage levels to the display elements 150. In implementations in which the display elements are shutter-based light modulators, such as the light modulators 102 depicted in FIG. 1A, these voltage levels are designed to set, in digital fashion, an open state, a closed state, or other discrete state to each of the shutters 108. In some implementations, the drivers are capable of switching between analog and digital modes.

The lamp driver 147 connects to a pulse modulator 149. The pulse modulator 14 is shown as a separate element. In some other implementations, the pulse modulator 149 for optical communication resides in the display controller 134 or the lamp driver 147. The pulse modulator 149 connects to a display controller 134 (also referred to as the controller 134). In some implementations, the controller 134 sends data to the pulse modulator 149 in either a serial or parallel fashion. In some implementations, the controller 134 sends control data to the pulse modulator 149. The control data can include movement instructions for moving the display elements in a manner that will modulate light to form an image on the display. The pulse modulator 149 receives the control data and generates a bit stream. The pulse modulator encodes the control data into the bit stream, such as a serial bit stream, using any suitable encoding technique. The serial bit stream is passed to the lamp driver 147 which drives lamps 140-148 to generate an optical signal that includes a sequence of light pulses. The control data can be encoded within the sequence of light pulses. The light pulses can provide an optical signal that is transmitted from the lamps 140-148. The optical receivers 131a-131e can detect and receive the sequence of light pulses and can provide the control data to the driver 130. The driver 130 can include series-to-parallel data converters, level-shifting, and for some applications digital-to-analog voltage converters.

The display apparatus 120 optionally includes a set of common drivers 138, also referred to as common voltage sources. In some implementations, the common drivers 138 provide a DC common potential to all display elements within the array of display elements 150. For example, by supplying voltage to a series of common interconnects 139. In some other implementations, the common drivers 138, following commands from the controller 134, issue voltage pulses or signals to the array of display elements 150. For example, global actuation pulses which are capable of driving and/or initiating simultaneous actuation to all display elements in multiple rows and columns of the array. Optionally, the global actuation pulses may be generated by the driver 130 in response to control data encoded within the optical signal transferred from the controller 134, through the optical signal generated by the lamps 140-148.

The controller 134 can coordinate the illumination of red, green, blue, white, and infrared lamps (140, 142, 144,146, and 148 respectively) via lamp driver 147, with the sequencing of movement of specific display elements within the array of display elements 150. In some implementations, the lamps are light emitting diodes (LEDs). In some implementations, the lamps will generate light signals within the visible spectrum. In some other implementations, the lamps will generate light in the infrared spectrum, such as lamp 148, or some other range of wavelengths in the electromagnetic spectrum. In some implementations, the wavelength used will depend upon the application being addressed and any wavelength suitable for transferring data in an optical signal may be employed.

The controller 134 determines the sequencing or addressing scheme by which each of the display elements can be reset to the illumination levels appropriate to a new image 104. The controller 134 has an interface capable of communicating with a host processor 122 to receive an image signal representative of an image for display. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of one or more of the lamps 140, 142, 144, 146, and 148 such that alternate image frames are illuminated with an alternating series of colors, such as red, green, blue, white, and infrared. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 through the driver 130 and to the array of display elements 150 by a sequential addressing of individual rows, also referred to as scan lines. For each row or scan line in the sequence, the driver 130 applies a write-enable voltage to the write enable interconnect 133 for that row of the array of display elements 150, and subsequently the driver 130 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 138 and 147 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

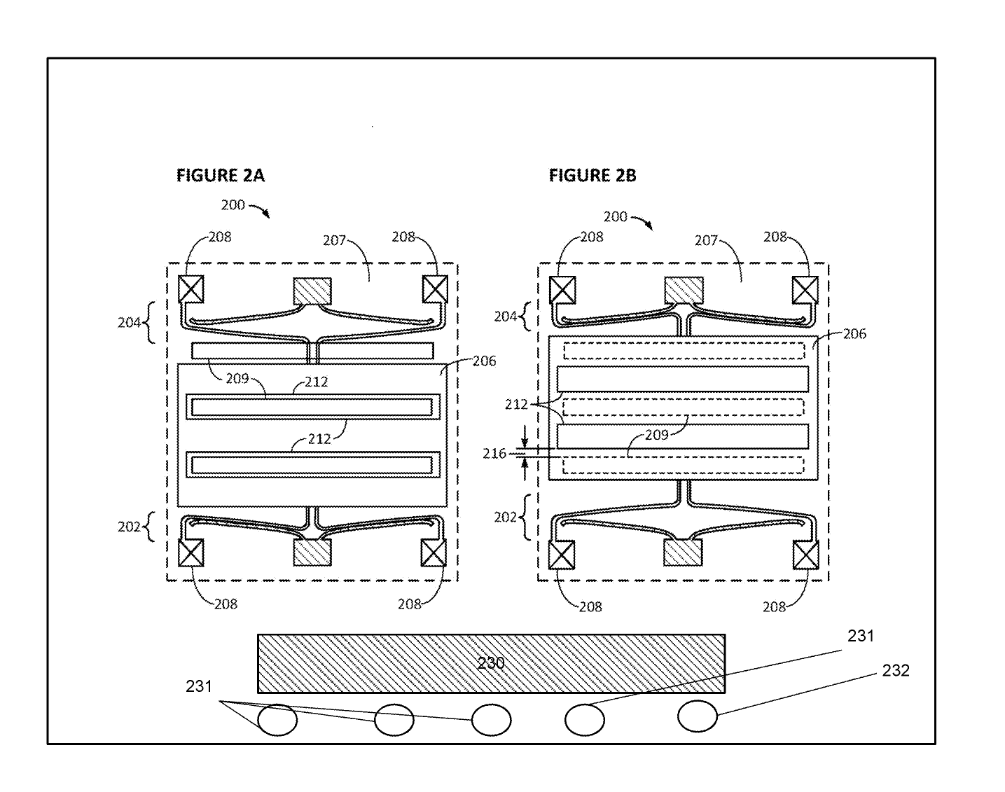

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ. The dual actuator shutter assembly 200 includes five optical detectors 231 and 232, including a λ_{X} optical detector 232 for detecting light in the infrared spectrum. In some implementations, the optical detectors 231 and 232 are integrated into the substrate supporting the shutter assembly 200. The five detectors 231 and 232 can be any suitable type of optical detector, such as photodiodes that respond to incident optical signals by converting the optical signal to an electrical signal through a transimpedance amplifier (TIA). The optical detectors 231 and 232 electrically couple to a driver 230 integrated into the substrate supporting the shutter assembly 200. The optical detectors 231 and 232 couple to the driver 230 to provide the dual actuator shutter assembly 200 with a receiver for receiving optical signals. The driver 230 can be a driver circuit, similar to the driver 130 described with reference to FIG. 1B. The driver 230 can connect to the control matrix described with reference to FIG. 1A as being coupled to the substrate and to the light modulators for controlling the movement of the shutters. The control matrix includes the electrical interconnects that carry electrical signals between the actuation elements and the control circuits. In operation, the driver 230 can drive the shutters 208 to switch between and open and closed state at a rate of between 20 Hz and 2 KHz.

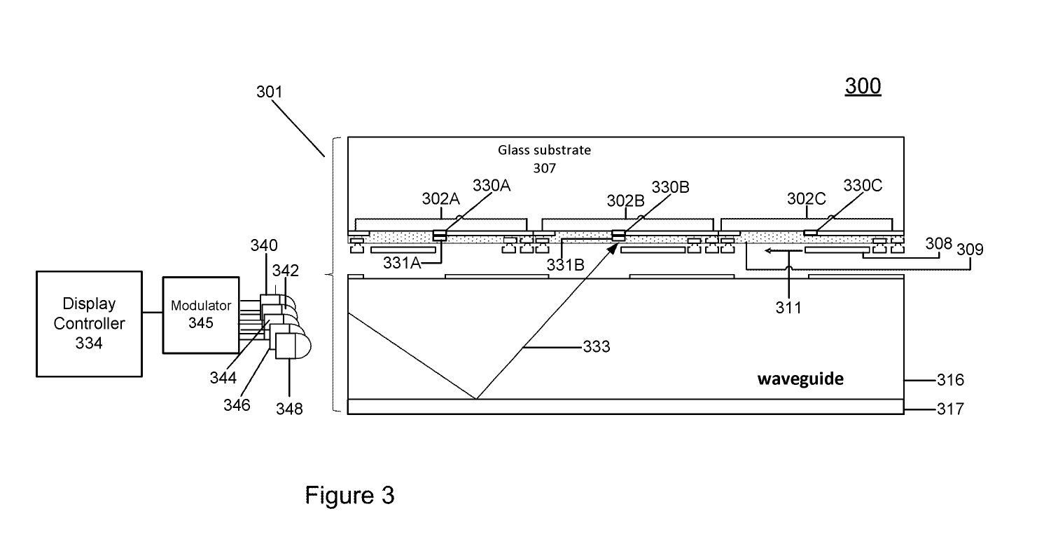

FIG. 3 shows an example display having an optical data connection between a controller and an array of display elements. In particular, FIG. 3 depicts a display system 300 that includes a display 301 that includes MEMS shutter devices 302a, 302b and 302c, a waveguide 316 and an optional reflective surface 317. Additionally, the system 300 includes a display controller 334, a modulator 345 and lamps 340, 342, 344, 346, and 348. In some implementations, the display system 300 employs the MEMS shutter devices 302a, 302b and 302c as display elements for modulating light to create an image on the display. A receiver 330 coupled to the MEMS shutter devices 302a, 302b and 302c can receive an optical signal sent from lamps 340, 342, 344, 346, and 348, that operate as transmitters of the optical signal. The lamps 340, 342, 344, 346, and 348 are coupled through the modulator 345 to the display controller 334 and transmit to the receiver 330 an optical signal that carries the control data for controlling operation of the light modulator.

The display 301 shows in cross-section the shutter assemblies 302a through 302c that modulate light passing through the waveguide 316. As described with reference to FIG. 1A, the MEMS shutter assemblies 302a through 302c each include a shutter 308 that can be driven to a position that either covers or uncovers an aperture 309. The direction of motion of a shutter 308 is depicted by arrow 311 which shows the direction of motion of the shutter 308 to pass over the aperture 309, thereby blocking light from traveling from the waveguide 316 through the aperture 309. Alternatively, when the shutter 308 is in the open position, as depicted for shutter assemblies 302b and 302c, the shutter 308 is laterally spaced away from the aperture 309 which thereby allows light from the waveguide 316 to pass through the aperture 309 and through the glass substrate 307 of the display 301.

Operation of the shutter 308 is controlled by a driver circuit 330 that generates actuation signals for causing the beam actuators, discussed with reference to FIGS. 2A and 2B, to move the shutter 308 relative to the aperture 309. The depicted display 301 includes three driver circuits 330a, 330b, and 330c. Each driver circuit 330 is formed on the substrate of the associated shutter assembly 302a through 302c. FIG. 3 further shows that driver circuits 330a and 330b include optical receivers 331a and 331b, respectively. The driver 330c of shutter assembly 302c does not include an optical receiver. The drivers 330a through 330c generate voltage pulses that actuate the shutters 308 to drive the shutters 308 between the open and closed positions. The driver circuits 330A and 330B are responsive to optical signals generated by the lamps 340 through 348. The lamps 340 through 348 are optical transmitters that transmit an optical signal such as the optical signal 333 that propagates through waveguide 316. The transmitters 340 through 348 are LED lamps that generate optical signals within the visible spectrum. As discussed with reference to FIG. 2A and FIG. 2B, the lamps 340 through 348 generate light that can pass through the shutter assemblies 302a through 302c to form an image along the surface of the glass substrate 307.

Display system 300 employs a display controller 334, a modulator 345 and the lamps 340 through 348 to generate an optical signal that includes control data and that can propagate optically through the waveguide 316 and be detected and received by the receivers 331a and 331b of the drivers 330. The control signal transmitted by the lamps 340 through 348 can include analog signals or digitally encoded signals that the driver circuit 330 can decode to create an actuation signal.

The system 300 depicted in FIG. 3 has four lamps, similar to the four visible color lamps 140 through 146 depicted in FIG. 1B. As discussed with reference to FIG. 1B, the lamps 340 through 348 may be individual colors, such as red, green, blue or white, and the controller can actuate different lamps to propagate signals of different colors through the waveguide 316 and toward the drivers 330. In some implementations, the driver 330 includes a color filter that filters the propagating signal 333 to select signals having a particular wavelength, or color.

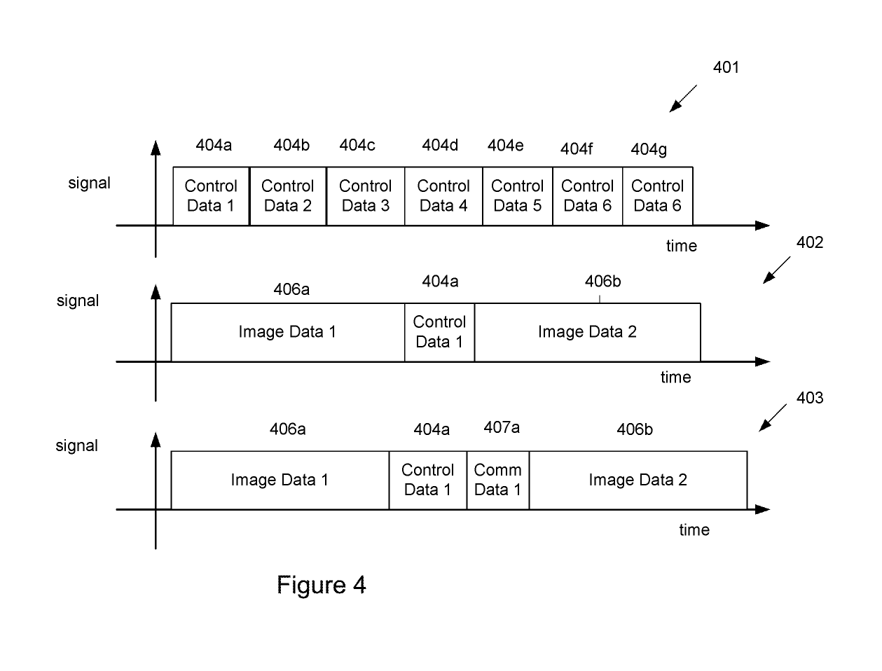

FIG. 4 shows example timing diagrams for signals communicated through an optical data connection. In particular, FIG. 4 depicts three example graphs 401, 402 and 403, with each graph showing timing diagrams representing an optical signal suitable for being transmitted from the lamps to the driver 330. The graphs are presented across two axes, one axis showing amplitude of the signal and the other axis showing time. Each graph depicts a series of data blocks being transferred across time. Graph 401 depicts a series of data blocks 404a-404g carrying control data transmitted for controlling the operation of the shutter assemblies, such as the shutter assemblies 302a through 302c depicted in FIG. 3. Each data block 404 can include a sequence of light pulses and the sequence of light pulses can serially transfer control data from the controller 334 to the driver 330. Graph 402 depicts a multiplexed data set that includes image data blocks 406a and 406b and control data 404a encoded in the same optical signal, such as the signal 333 depicted in FIG. 3. Graph 402 depicts a time division multiplexing (TDM) data transfer technique that transfers the image data and the control data in blocks 406a, 406b and 404a that are multiplexed together. In graph 402 image data for a red sub-image is transferred in data block 406a and image data for the white sub-image is transferred in data block 406b, with control data carried in data block 404a. The control data can provide movement instructions to reconfigure the display elements 150 from the configuration used for the red sub-image to the configuration to be used for the white sub-image. The multiplexed data blocks 404 and 406 can be generated by a multiplexer that multiplexes control data and image data into a stream of serial data that can be passed to the modulator 345 so that the lamps 340-348 generate a series of optical pulses that carry the control and image data in a multiplexed form. In some implementations, the multiplexer may be a software process executing on the controller 334 and being capable of multiplexing image and control data together. In some implementations, the multiplexer may be a circuit capable of multiplexing digital data. In some implementations, the multiplexer can mix together different data signals, such as image data, control data and communication data, to generate a data signal that carries the different data signals together to create a multiplexed signal, such as the time division multiplexed signals shown in graphs 402 and 403. Graph 403 depicts further multiplexing of data within the optical signal. In graph 403, the signal includes image data, control data and communication data that propagate within the signal 333 through waveguide 316 to the drivers 330. In graph 403 the image data is carried in image data blocks 404a and 404b. The control data is carried in control data block 406a and the communication data is carried in communication data block 407a. The data blocks are multiplexed together over time, to spread temporally the different types of data within the optical signal.

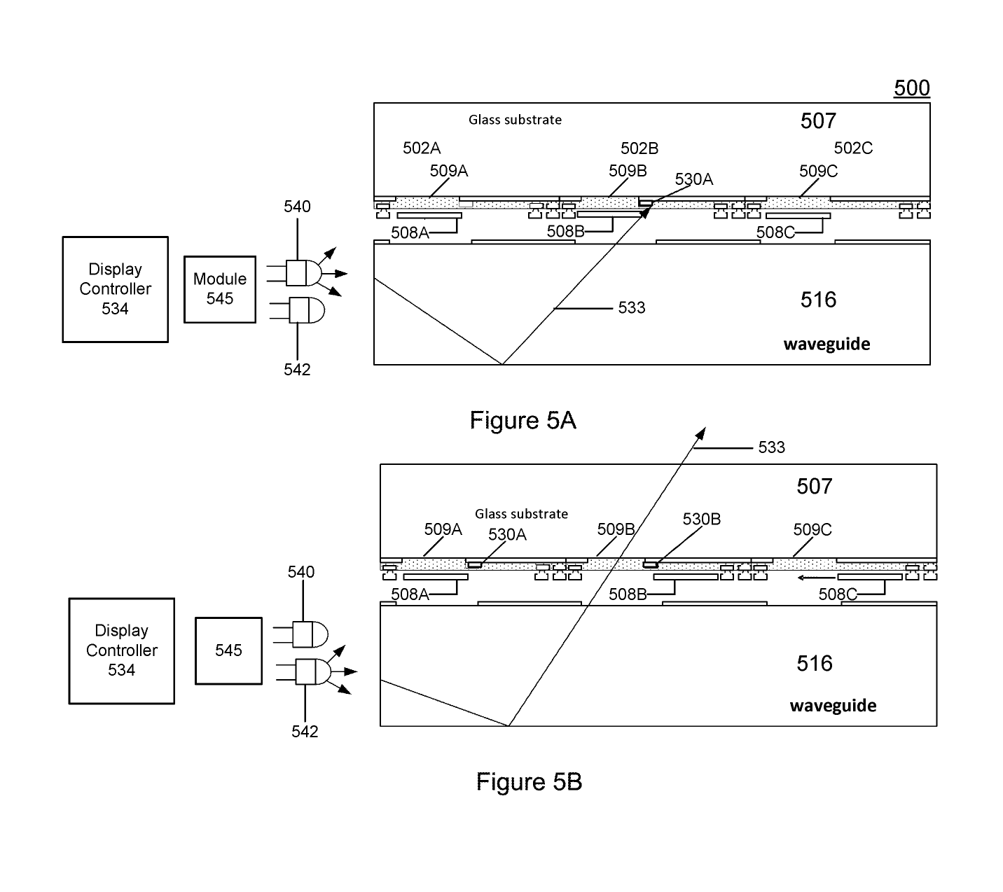

The communication data block 407a carries communication data, and in some implementations, the communication data in data block 407a is transmitted through the display and to a remote location. FIGS. 5A and 5B show an example display having an optical data connection for communicating with a display element and with a remote device. FIG. 5A shows a display 500 that includes a display controller 534, a modulator 545, lamps 540 and 542, a waveguide 516, a glass substrate 507 and shutter assemblies 502a-502c. In FIG. 5A the display 500 is in an operational state where the lamp 540 is depicted as being active by showing the light rays emanating from the lamp. In contrast, the lamp 542 has no rays emanating from its surface and is therefore depicted as inactive. In some implementations, the lamp 540 generates an optical signal 533 that transmits control data from the display controller 534 to the optical receivers 530A and 530B. The control data has information for moving the shutters 508 relative to the apertures 509. The light ray 533 propagates from the lamp 540, through the waveguide 516 and to the receiver 530A. In such an implementation, the control data is generated by a dedicated lamp, such as the lamp 540, and the control signal 533 is transmitted when all the shutters 508 are in a closed position. The sequence control can be carried out by the display controller 534. In some implementations, a sequence control process executed in the display controller 534 can generate the sequence of movement operations that move the light modulators to block light from passing through the apertures prior to transmitting an optical signal carrying control data. In contrast, FIG. 5B shows an operational state in which the lamp 542 is active and that the lamp 540 is inactive. The lamp 542 can generate an optical signal carrying communication data. In this state, at least one shutter 508 is in the open position. The optical signal generated by the lamp 542 is optically coupled to the waveguide 516 to propagate through the waveguide 516 and pass through the open aperture 509b. The optical signal 533 passes through the glass substrate 507 and travels out of and away from the display 500. In this way, the optical signal 533 can carry communication data to a location that is remote from the display 500.

The sequential activation of the lamps 540 and 542 shown in FIGS. 5A and 5B provides an example implementation of a TDM optical signal. This TDM optical signal is generated from two or more light sources, activated sequentially. In some other implementations, a single light source is used and the signal may be subdivided into time periods dedicated to different data types, or may include meta-data, such as packet header data, that indicates the data type of a data block. FIG. 4 depicts three examples of TDM data transfer techniques. However, other data transfer techniques may be employed including wavelength division multiplexing (WDM). In some implementations, a light source having a particular wavelength, such as 495-570 nm (green light) is activated during a set time period, T₁. Receivers 531 having filters that pass that particular wavelength range can receive the data blocks transmitted during that time period. During the same time period, T₁, another light source having a different wavelength, such as 625-750 nm may be activated. Receivers 530A and 530B having filters that pass that range of wavelengths, 625-750 nm, can detect and receive control signals carried within that optical signal.

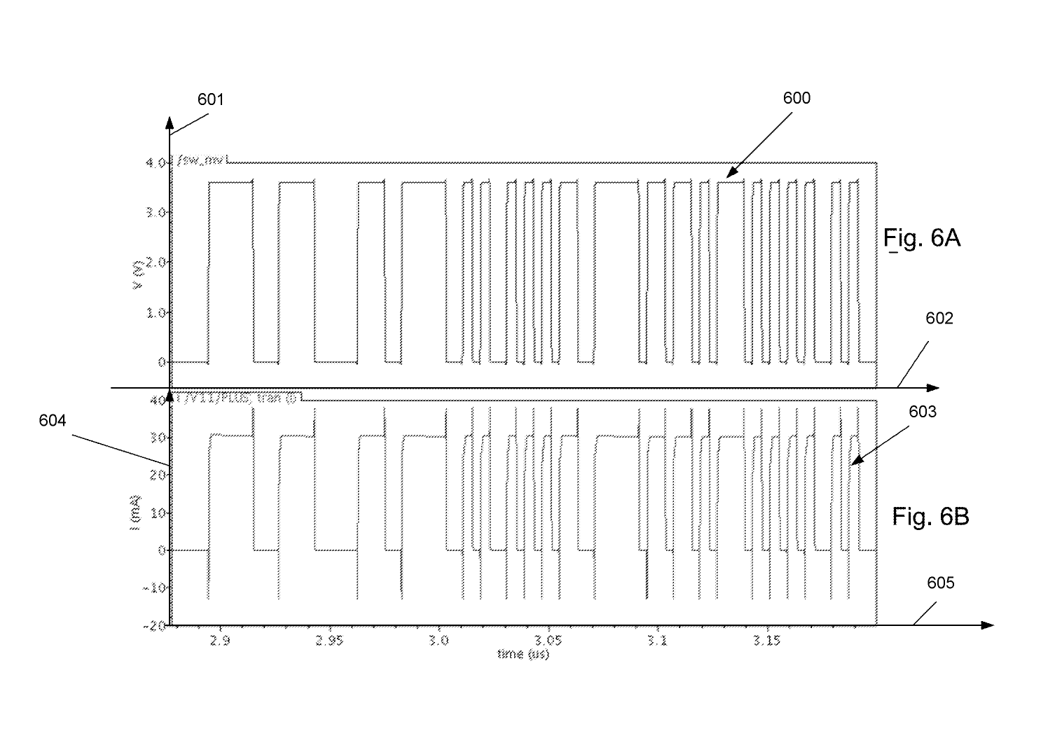

FIGS. 6A and 6B show an example of data to be encoded in an optical signal. FIG. 6A shows a sequence of voltage pulses 600 switching between two voltage levels. The voltage pulses 600 represent voltage levels being used to generate the optical signal that will carry data to a driver, such as driver 330. FIG. 6A plots the voltage levels against two axes, axis 601 measuring voltage and axis 602 measuring time. The time measurements on axis 602 range from 2.9 μsecs to about 3.15 μsecs. The example is of a 250 Mbps double-data rate (DDR) (equivalent to 8 ns pulse width) pseudo-random bit sequence (PRBS). The voltage levels switch between 0 Volts and 3.6 Volts, and the two different levels can represent binary data. The binary data encoded into the voltage pulses 600 can be used to generate a series of optical pulses that carry the encoded binary data to the driver 330. To this end, the sequence of voltage pulses 600 can be used to generate a series of current pulses that can switch an LED lamp between an on and an off condition. FIG. 6B shows a sequence of current levels 603 switching between two levels and represents current levels passed through an LED lamp to drive the lamp to generate the optical signal that will carry data to the driver. FIG. 6B plots the current level against two axes, axis 604 which measures current levels and axis 605 that measures time. FIG. 6A shows that the voltage levels can switch at a frequency of about 250 Mbps DDR, such that a pulse is about 8 nanoseconds in duration. Encoding data into an optical signal at a frequency that is above human visual perception, such as about 60 Hz, allows the optical signal to be transferred during formation of an image on the display without creating a visual artifact on the display.

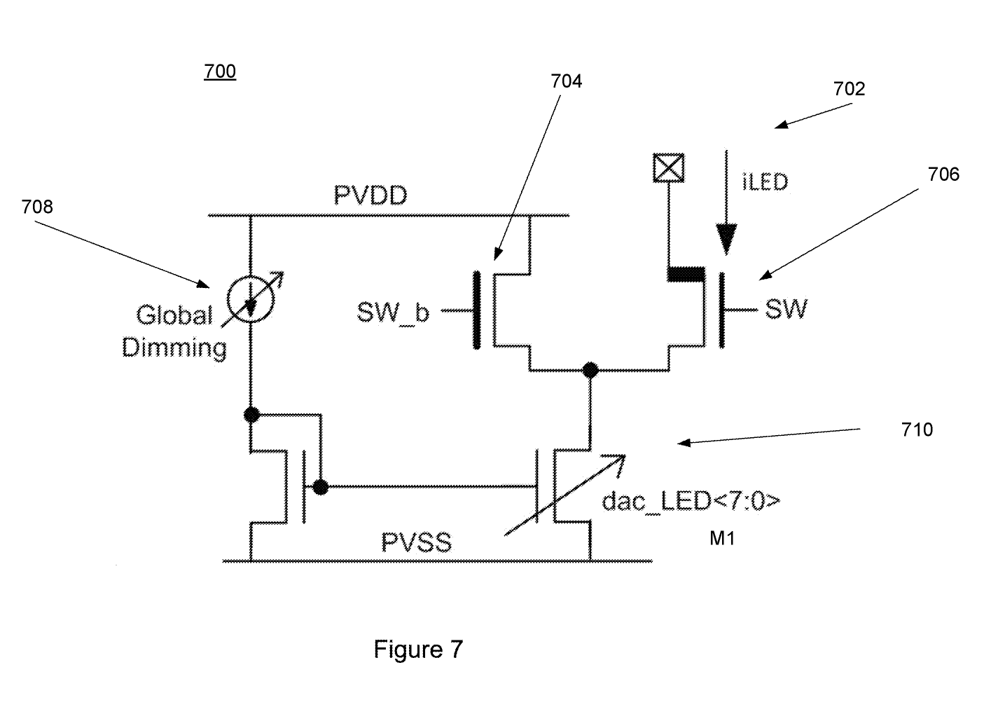

FIG. 7 shows an example lamp driver for high frequency switching of a lamp. In particular FIG. 7 shows a switching circuit 700 for generating the optical signal as a series of optical pulses. The switching circuit 700 includes a pair of coupled transistors 704 and 706 that regulate the flow of current iLED 702 to the transistor (710.The transistors 704 and 706 are set up as a differential pair to provide quick switching of the iLED current 702. Transistor 704 is set at some bias value SW_b. The magnitude of the current iLED is controlled by the transistor 710, and the current iLED is switched by transistors 704 and 706. The differential pair transistors 704 and 706 switch iLED 702 to pass through the LED lamps, such as the LED lamps 340-348 shown in FIG. 3, in response to the signal 706. Additionally, and optionally, the circuit 700 includes a dimming sensor 708 that allows an external signal to control the current iLED 702 to adjust for conditions, such as the brightness of the environment in which the display is operating. A signal, such as the voltage pulses 600 can be applied to transistor 706 to switch the current iLED 710 on and off. The current iLED 702 through the transistor 710 can be similar to the sequence of current levels 603 shown in FIG. 6B.

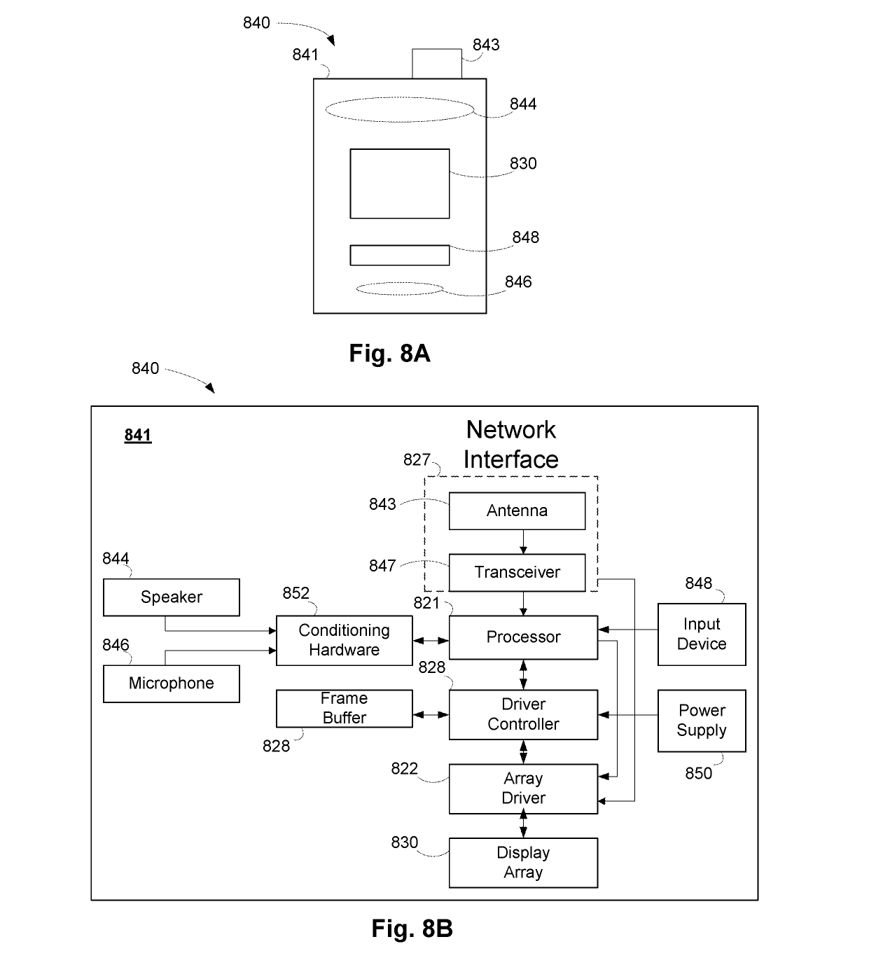

FIGS. 8A and 8B show system block diagrams of an example display device 840 that includes a plurality of display elements. The display device 840 can be, for example, a smart phone, a cellular or mobile telephone. However, the same components of the display device 840 or slight variations thereof are also illustrative of various types of display devices such as televisions, computers, tablets, e-readers, hand-held devices and portable media devices.

The display device 840 includes a housing 841, a display 830, an antenna 843, a speaker 845, an input device 848 and a microphone 846. The housing 841 can be formed from any of a variety of manufacturing processes, including injection molding, and vacuum forming. In addition, the housing 841 may be made from any of a variety of materials, including, but not limited to: plastic, metal, glass, rubber and ceramic, or a combination thereof. The housing 841 can include removable portions (not shown) that may be interchanged with other removable portions of different color, or containing different logos, pictures, or symbols.

The display 830 may be any of a variety of displays, including a bi-stable or analog display, as described herein. In addition, the display 830 can include a mechanical light modulator-based display, as described herein.

The components of the display device 840 are schematically illustrated in FIG. 8A and 8B. The display device 840 includes a housing 841 and can include additional components at least partially enclosed therein. For example, the display device 840 includes a network interface 827 that includes an antenna 843 which can be coupled to a transceiver 847. The network interface 827 may be a source for image data that could be displayed on the display device 840. Accordingly, the network interface 827 is one example of an image source module, but the processor 821 and the input device 848 also may serve as an image source module. The transceiver 847 is connected to a processor 821, which is connected to conditioning hardware 852. The conditioning hardware 852 may be configured to condition a signal (such as filter or otherwise manipulate a signal). The conditioning hardware 852 can be connected to a speaker 845 and a microphone 846. The processor 821 also can be connected to an input device 848 and a driver controller 829. The driver controller 829 can be coupled to a frame buffer 828, and to an array driver 822, which in turn can be coupled to a display array 30. One or more elements in the display device 840, including elements not specifically depicted in FIG. 8A, can be capable of functioning as a memory device and be capable of communicating with the processor 821. In some implementations, a power supply 50 can provide power to substantially all components in the particular display device 840 design.

The network interface 827 includes the antenna 843 and the transceiver 847 so that the display device 840 can communicate with one or more devices over a network. The network interface 827 also may have some processing capabilities to relieve, for example, data processing requirements of the processor 821. The antenna 843 can transmit and receive signals. In some implementations, the antenna 843 transmits and receives RF signals according to any of the IEEE 16.11 standards, or any of the IEEE 802.11 standards. In some other implementations, the antenna 843 transmits and receives RF signals according to the Bluetooth® standard. In the case of a cellular telephone, the antenna 843 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 847 can pre-process the signals received from the antenna 843 so that they may be received by and further manipulated by the processor 821. The transceiver 847 also can process signals received from the processor 821 so that they may be transmitted from the display device 840 via the antenna 843.

In some implementations, the transceiver 847 can be replaced by a receiver. In addition, in some implementations, the network interface 827 can be replaced by an image source, which can store or generate image data to be sent to the processor 821. The processor 821 can control the overall operation of the display device 840. The processor 821 receives data, such as compressed image data from the network interface 827 or an image source, and processes the data into raw image data or into a format that can be readily processed into raw image data. The processor 821 can send the processed data to the driver controller 829 or to the frame buffer 828 for storage. Raw data typically refers to the information that identifies the image characteristics at each location within an image. For example, such image characteristics can include color, saturation and gray-scale level.

The processor 821 can include a microcontroller, CPU, or logic unit to control operation of the display device 840. The conditioning hardware 852 may include amplifiers and filters for transmitting signals to the speaker 845, and for receiving signals from the microphone 846. The conditioning hardware 852 may be discrete components within the display device 840, or may be incorporated within the processor 821 or other components.

The driver controller 829 can take the raw image data generated by the processor 821 either directly from the processor 821 or from the frame buffer 828 and can re-format the raw image data appropriately for high speed transmission to the array driver 822. In some implementations, the driver controller 829 can re-format the raw image data into a data flow having a raster-like format, such that it has a time order suitable for scanning across the display array 830. Then the driver controller 829 sends the formatted information to the array driver 822. Although a driver controller 829 is often associated with the system processor 821 as a stand-alone Integrated Circuit (IC), such controllers may be implemented in many ways. For example, controllers may be embedded in the processor 821 as hardware, embedded in the processor 821 as software, or fully integrated in hardware with the array driver 822.

The array driver 822 can receive the formatted information from the driver controller 829 and can re-format the video data into a parallel set of waveforms that are applied many times per second to the hundreds, and sometimes thousands (or more), of leads coming from the display's x-y matrix of display elements. In some implementations, the array driver 822 and the display array 830 are a part of a display module. In some implementations, the driver controller 829, the array driver 822, and the display array 30 are a part of the display module.

In some implementations, the driver controller 829, the array driver 822, and the display array 830 are appropriate for any of the types of displays described herein. For example, the driver controller 829 can be a conventional display controller or a bi-stable display controller (such as a mechanical light modulator display element controller). Additionally, the array driver 822 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 829 can be integrated with the array driver 822. Such an implementation can be useful in highly integrated systems, for example, mobile phones, portable-electronic devices, watches or small-area displays.

In some implementations, the input device 848 can be configured to allow, for example, a user to control the operation of the display device 840. The input device 848 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 846 can be configured as an input device for the display device 840. In some implementations, voice commands through the microphone 846 can be used for controlling operations of the display device 840. Additionally, in some implementations, voice commands can be used for controlling display parameters and settings.

The power supply 850 can include a variety of energy storage devices. For example, the power supply 850 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 850 also can be a renewable energy source, a capacitor, or a solar cell, including a plastic solar cell or solar-cell paint. The power supply 850 also can be configured to receive power from a wall outlet.

In some implementations, control programmability resides in the driver controller 829 which can be located in several places in the electronic display system. In some other implementations, control programmability resides in the array driver 822. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display, comprising
a light modulator capable of modulating light and including a receiver for receiving optical signals,
a display controller capable of generating control data for operating the light modulator, and
a transmitter coupled to the display controller and capable of transmitting to the receiver an optical signal carrying the control data for controlling operation of the light modulator.

2. The display of claim 1, wherein the receiver includes a driver circuit coupled to the light modulator and having an optical detector capable of detecting optical signals.

3. The display of claim 1, further comprising an interface capable of communicating with a processor to receive an image signal representative of an image for display.

4. The display of claim 1, wherein the transmitter includes a switching circuit capable of generating the optical signal as a series of optical pulses.

5. The display of claim 4, wherein the switching circuit switches at a rate of between 2 KHz and 500 MHz.

6. The display of claim 1, further comprising a waveguide optically coupled to the transmitter capable of carrying the optical signal to the receiver.

7. The display of claim 1, wherein the light modulator includes an array of light modulators arranged in alignment with an array of apertures.

8. The display of claim 7, further comprising a sequence controller capable of moving the light modulators to block light from passing through the apertures prior to transmitting an optical signal carrying control data.

9. The display of claim 1, wherein the transmitter includes an infrared light source capable of generating the optical signal in the infrared spectrum.

10. The display of claim 1, wherein the transmitter includes a light source capable of generating the optical signal with a plurality of wavelengths.

11. The display of claim 10, wherein the receiver includes a color filter capable of filtering the optical signal.

12. The display of claim 1, further comprising a multiplexer capable of encoding communication data and control data within the optical signal.

13. The display of claim 1, further comprising signaling links capable of electrically connecting the controller with the light modulator.

14. The display of claim 1, further comprising
a processor capable of communicating with the display, the processor being capable of processing image data; and
a memory device capable of communicating with the processor.

15. The display of claim 14, further comprising:
an image source module capable of sending the image data to the processor, wherein the image source module includes at least one of a receiver, transceiver, and transmitter.

16. The display of claim 14, further comprising:
an input device capable of receiving input data and communicating the input data to the processor.

17. A display device, comprising
a light modulator including a receiver for receiving optical signals;
a controller capable of generating control data for operating the light modulator;
a processor, wherein the processor is capable of generating a communication signal having encoded information; and
a transmitter coupled to the controller, wherein the transmitter is capable of transmitting an optical signal carrying the control data to the receiver, and an optical signal carrying the communication signal.

18. The display device of claim 17, wherein the transmitter is capable of transmitting the optical signal carrying the communication signal to a remote location.

19. The display device of claim 17, further comprising a multiplexer capable of encoding the communication signal and the control data within the optical signal.

20. The display device of claim 17, wherein the transmitter includes a switching circuit capable of generating the optical signal as a series of optical pulses.

21. The display of claim 20, wherein the switching circuit switches at a rate of between 2 KHz and 500 MHz.

22. The display of claim 21, wherein the communication signal has a data transmission rate of 2 Kbps to 500 Mbps.

23. The display of claim 17, wherein the light modulator includes an array of light modulators arranged in alignment with an array of apertures.

24. The display of claim 17, further comprising a spatial multiplexer capable of multiplexing the communication signal across a plurality of apertures within the array.

25. A system for communicating information to a remote location, comprising:
a transmitter having a display including:
a light modulator positioned in alignment with an aperture, the light modulator capable of moving between an open and closed position to modulate light passing through the aperture;
a communication processor capable of generating an optical communication signal having encoded information; and
a transmitter coupled to the communication processor capable of transmitting through the aperture when the light modulator is in the open position, the optical communication signal transmitting to a remote location.

26. The system of claim 25 further comprising,
a display controller capable of controlling the light modulator to form an image and moving the light modulator to an open position during formation of an image to allow the optical communication signal to pass through the aperture.

27. The system of claim 26, wherein the display controller moves the light modulator between an open and closed position at a frequency greater than 60 Hz.
